(19) United States
(12) Patent Application Publication
(10) Pub. No.: US 2025/0174237 A1
(43) Pub. Date: May 29, 2025

(54) OPTIMISED ENCODING AND DECODING OF AN AUDIO SIGNAL USING A NEURAL NETWORK-BASED AUTOENCODER

(71) Applicant: Orange, Issy-les-Moulineaux (FR)

(72) Inventors: Stéphane Ragot, Chatillon (FR); Mohamed Yaoumi, Chatillon (FR)

(21) Appl. No.: 18/842,652

(22) PCT Filed: Feb. 28, 2023
(86) PCT No.: PCT/EP2023/054894

§ 371 Date: Aug. 29, 2024

(30) Foreign Application Priority Data
Mar. 2, 2022 (FR) 2201831

(51) Int. Cl. G10L 19/008; G10L 25/30

(52) U.S. Cl. CPC G10L 19/008; G10L 25/30

(57) ABSTRACT

A method for encoding an audio signal. The method includes: decomposing the audio signal into at least amplitude components and sign or phase components; analyzing the amplitude components, using a neural network-based autoencoder, in order to obtain a latent space representative of the amplitude components of the audio signal; encoding the latent space obtained; encoding at least some of the sign or phase components. A corresponding decoding method, as well as to encoding and decoding devices implementing the respective encoding and decoding methods are also provided.

### TECHNICAL FIELD

The present invention relates to the general field of the coding and decoding of audio signals. The invention relates in particular to the optimized use of a neural network-based autoencoder for coding and decoding an audio signal.

### PRIOR ART

In conventional audio signal coding and decoding systems, the input audio signal is generally converted into a frequency domain either using a filter bank or by applying a short-time transform, in order to obtain a beneficial coding gain and exploit the psychoacoustic properties of human auditory perception. Indeed, these psychoacoustic properties are exploited for example by distributing the bit budget non-uniformly and/or adaptively as a function of the frequency bands. The time-to-frequency conversion may then be seen as a transformation to a representation more suitable for carrying out coding at a given bit rate. The decoder, for its part, has to reverse this transformation. For a lossy compression system, the general objective is to find a representation of the signal that is as suitable as possible for coding at the lowest possible bit rate at a given quality or, conversely, with the best possible quality at a given bit rate. In the field of audio, it is possible to exploit perceptual considerations due to imperfections of the human ear (for example masking phenomenon, etc.) so as to achieve a compromise between bit rate and (perceptual) distortion that is even better than with conventional non-perceptual coding.

Some examples of conventional audio codecs are given by MPEG Audio standards (for example MP3, AAC, etc.) or other standards (for example UIT-T G.722.1, G.719). In general, these codecs have architectures comprising various signal processing modules or quantization/coding modules, which are optimized separately.

Recently, new approaches to signal compression have emerged through the use of neural networks carrying out what is referred to as end-to-end learning. With the generalization of GPU (graphical processing unit) architectures or other specialist processors for neural networks, this type of neural network-based coding approach is promising and could eventually replace traditional audio codecs.

One example of a neural network architecture applied to the field of image and video compression is described in the following articles:

“Johannes Ballé, Valero Laparra, Eero P. Simoncelli, End-to-end Optimized Image Compression, Int. Conf. on Learning Representations (ICLR), 2017” and “Johannes Ballé, David Minnen, Saurabh Singh, Sung Jin Hwang, Nick Johnston, Variational image compression with a scale hyperprior, Int. Conf. on Learning Representations (ICLR), 2018”.

These methods are based on the principle of (conventional) autoencoders and what are known as variational autoencoders (VAE).

Autoencoders are artificial neural network-based learning algorithms that make it possible to construct a new, more compact (compressed) representation of a dataset. The architecture of an autoencoder consists of two parts or operators: the encoder (analysis part) f (x), which transforms the input data x into a representation z, and the decoder (synthesis part) g (z), which resynthesizes the signal from z. The encoder consists of a set of neural layers, which process the input data x in order to construct a new representation referred to as a “latent space” (or hidden variables) z of small dimension. This latent space represents the important characteristics of the input signal in a compact form. The neural layers of the decoder receive the latent space at input and process same in order to attempt to reconstruct the starting data. The differences between the reconstructed data and the initial data make it possible to measure the error made by the autoencoder. The training consists in modifying the parameters of the autoencoder in order to reduce the reconstruction error measured on the various samples of the dataset. Various error criteria are possible, such as for example the mean squared error (MSE). Unlike a conventional autoencoder, a variational autoencoder (VAE) adds a representation of the latent space through a multivariate Gaussian model (means and variances) of the latent space. A VAE also consists of an encoder (or inference or recognition model) and of a decoder (or generative model). A VAE attempts to reconstruct the input data like an autoencoder, but the latent space of a VAE is continuous.

The methods of Balle et al. use network architectures based on 2D convolutional networks (with for example, in one embodiment, a filter of size 5×5 and decimation or oversampling—respectively—by 2 in each encoding or decoding layer); an adaptive normalization, referred to as GDN (Generalized Divisive Network), is applied between each layer, thereby improving performance compared to batch normalization.

It should be noted that the methods of Balle et al. use an approximation of the coding of the space through a simplified quantization model (addition of noise) with a Gaussian model for learning, but the latent space is actually coded directly, this being tantamount to conventional (or deterministic) autoencoder methods.

The direct application of the abovementioned methods of Ballé et al., originating from image and video compression, to the compression of audio signals is not satisfactory. Indeed, an image or a video sequence consists of pixels, which may be seen as random variables with integer values over a predefined interval, for example [0, 255] for images or video having a resolution of 8 bits per pixel. These pixels have only positive values. Audio signals, by contrast, generally have signed values. In addition, audio signals, after a time/frequency transformation, may be real or complex. In addition, the spectral dynamic range in the audio domain is larger than in the image or video domain; it is of the order of 16 bits per sample (or even more for what is known as “high-resolution” audio). Transposing an autoencoder architecture similar to Ballé et al. directly to audio gives relatively poor results, in particular in terms of reconstruction quality.

There is therefore a need to optimize autoencoder coding techniques for the field of audio coding/decoding.

### SUMMARY OF THE INVENTION

The invention aims to improve the prior art.

To this end, the invention targets a method for coding an audio signal, comprising the following steps:
decomposing the audio signal into at least amplitude components and sign or phase components;
analyzing the amplitude components by way of a neural network-based autoencoder so as to obtain a latent space representative of the amplitude components of the audio signal;
coding the obtained latent space;
coding at least a portion of the sign or phase components.

The invention makes it possible to apply, in optimized fashion, autoencoders using neural networks for coding/decoding audio signals. The differentiated coding of the sign component or of the phase component, depending on the signal decomposition method, makes it possible to guarantee good audio quality. According to the invention, this quality may achieve performance as far as transparency at a sufficient bit rate, that is to say the quality of the decoded signal is very close to that of the original signal.

The method that is used is an end-to-end method that does not require independent optimization of the various coding modules. The method also does not need to take into account any perceptual considerations like traditional audio coding methods.

In one particular embodiment, the method furthermore comprises a step of compressing the amplitude components before they are analyzed by the autoencoder.

The data at the input of the autoencoder are thus restricted, so as to optimize the analysis and obtainment of the resulting latent space.

In one exemplary embodiment, the amplitude components are compressed by a logarithmic function.

This type of low-complexity compression provides advantageous compression performance so as to reduce the dynamic range of the data at the input of the autoencoder.

In one embodiment, the audio signal before the decomposition step is obtained by an MDCT transform applied to an input audio signal.

In one embodiment, the audio signal is a multichannel signal.

In another embodiment of the invention, the audio signal is a complex signal comprising a real and an imaginary part resulting from a transformation of an input audio signal, the amplitude components resulting from the decomposition step corresponding to the amplitudes of the combined real and imaginary parts and the sign or phase components corresponding to the signs or phases of the combined real and imaginary parts. This type of frequency representation through MDCT or through another transform of the audio signal offers an advantage to the use of the coding method according to the invention, since it puts the signal into a time/frequency representation similar to a spectrogram, thereby making it more naturally possible to apply image or video compression methods to the amplitudes; the signs or phases are coded separately for better efficiency.

In one embodiment, all of the sign or phase components of the audio signal are coded. This solution has the advantage of being simple, but requires a sufficient bit rate.

In one particular embodiment, only the sign or phase components corresponding to the low frequencies of the audio signal are coded.

It is thus possible to optimize the coding bit rate by coding only a portion of the signs or phases, thereby reducing the additional bit rate needed to code the signs or phases, without otherwise significantly impacting the quality of the signal reconstructed during decoding.

In one variant embodiment, the sign or phase components corresponding to the low frequencies of the audio signal are coded and selective coding is carried out for the sign or phase components corresponding to the high frequencies of the audio signal.

This makes it possible to obtain certain sign or phase components of the high frequencies in optimized fashion while still reducing the coding bit rate.

In one embodiment, the positions of the sign or phase components selected for the selective coding are also coded, so as thus to recover the selection that was made during coding.

However, this solution requires an additional coding bit rate to code these positions.

In another embodiment, the positions of the selected sign or phase components and the associated values are coded together, thereby making it possible to optimize the coding bit rate for coding this information and recovering it during decoding.

The invention also relates to a method for decoding an audio signal, comprising the following steps:
decoding sign or phase components of the audio signal;
decoding a latent space representative of amplitude components of the audio signal;
synthesizing the amplitude components of the audio signal by way of a neural network-based autoencoder, from the decoded latent space;
combining the decoded amplitude components and the decoded sign or phase components so as to obtain a decoded audio signal.

The decoding method provides the same advantages as the coding method described above.

In one particular embodiment, if the decoded phase components correspond to one portion of the phase components of the audio signal, the other portion is reconstructed before the combining step.

It is thus possible to optimize the coding bit rate of the sign or phase information by coding and decoding only one portion, and to reconstruct the other portion in order to recover all of the sign or phase components during decoding.

The invention targets a coding device comprising a processing circuit for implementing the steps of the coding method as described above.

The invention also targets a decoding device comprising a processing circuit for implementing the steps of the decoding method as described above.

The invention relates to a computer program comprising instructions for implementing the coding or decoding methods as described above when they are executed by a processor.

Finally, the invention relates to a storage medium able to be read by a processor and storing a computer program comprising instructions for executing the coding method or the decoding method described above.

### BRIEF DESCRIPTION OF THE DRAWINGS

Other features and advantages of the invention will become more clearly apparent on reading the following description of particular embodiments, which are given by way of mere illustrative and non-limiting examples, and the appended drawings, in which:

FIG. 1a illustrates an encoder and a decoder respectively implementing a coding and a decoding method according to a first embodiment of the invention;

FIG. 1b illustrates one example of coding and multiplexing of sign bits according to the invention;

FIG. 1c illustrates one example of coding and multiplexing of sign bits with selection of high-frequency bits according to the invention;

FIG. 1d illustrates an encoder and a decoder respectively implementing a coding and a decoding method according to one variant embodiment of the invention;

FIG. 2a illustrates one exemplary embodiment of the analysis and synthesis parts of an autoencoder used according to the invention;

FIG. 2b illustrates one example of an input/output format for the analysis part of an autoencoder used according to the invention;

FIG. 2c illustrates one example of an input/output format for the synthesis part of an autoencoder used according to the invention;

FIG. 3a illustrates an encoder and a decoder respectively implementing a coding and a decoding method according to a second embodiment of the invention;

FIG. 3b illustrates an encoder and a decoder respectively implementing a coding and a decoding method according to a third embodiment of the invention; and

FIG. 4 illustrates examples of structural embodiments of a coding device and of a decoding device according to one embodiment of the invention.

### DESCRIPTION OF THE EMBODIMENTS

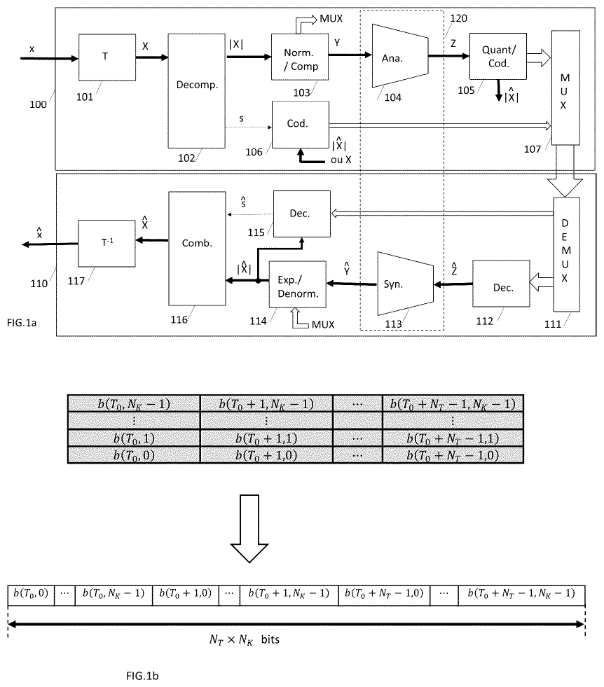

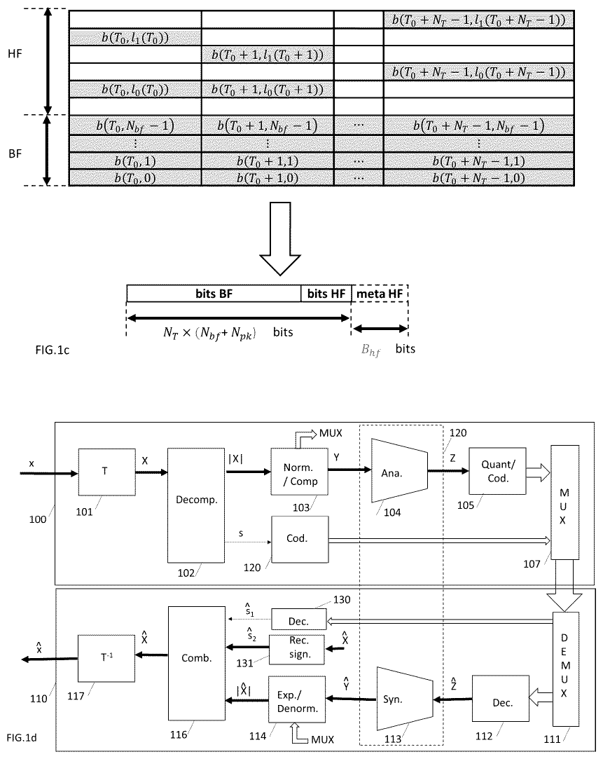

FIG. 1a describes a first embodiment of an encoder and of a decoder according to the invention, along with the steps of a coding method and of a decoding method according to a first embodiment of the invention.

The codec shown in FIG. 1a comprises an encoder (100) and a decoder (110).

The encoder 100 receives, at input, an input audio signal x, sampled at a frequency fs (for example 48 kHz) and divided into successive temporal frames of index t and of length L>1 sample(s), for example L=240 (5 ms); this signal x may be a mono (one-dimensional) signal denoted x(t,n), where n is the time index, or a multichannel signal denoted x(i,t,n), where i=0, . . . ,C−1 is the index of the channel and C>1 is the number of channels. In one exemplary embodiment, it is possible to take C=2 for a stereo signal or C=4 for an ambisonic signal of order 1.

The coding is carried out on a number of frames N_{T}≥1, where t=T₀ . . . , T₀+N_{T}−1, where T₀ is a frame index identifying the first analyzed frame in the group of analyzed frames. Typically, T₀ may start at T₀=0 by convention, and then T₀ is incremented by N_{T}. L samples in each group of analyzed frames.

A time/frequency transformation is applied to the input signal x at 101. Generally speaking, this transformation may be carried out by way of a frequency transform described below (MDCT, STFT, etc.) or by a bank of filters (PQMF, CLDFB, etc.) so as to obtain the transformed signal X.

In a given frame and for the mono case with transform coding, this (real or complex) transformed signal is denoted X(t,k), where k is a frequency index. It should be noted that the filter banks may operate in subframes and generate a set of (real or complex) samples per subframe; in this case, the transformed signal will be denoted X(t′,k), where t′ is a time index(of subframes) and k is a frequency index.

In the multichannel case, these notations are generalized as: X(i,t,k), where a transform is determined separately for each channel, or X(i,t′,k) for the case of filter banks.

In a first embodiment, consideration is given to the case of a modified discrete cosine transform (MDCT) for a mono signal. In this case, the signal x(t,n), n=0, . . . , L−1 in the current frame of index t is analyzed with an additional segment of L future samples that correspond to the future frame x(t,n), n=L, . . . , 2L−1, with the convention that x(t,n)=x(t+1,n−L) for n=L, . . . ,2L−1.

The MDCT transform is defined by:

$$X ( t , k ) = {\sum }_{n = 0}^{2 L - 1} \sqrt{\frac{2}{L}} sin ( \frac{π}{2 L} ( n + 0.5 ) ) cos ( \frac{π}{L} ( n + \frac{L}{2} + 0.5 ) ( k + 0.5 ) x ( t , n ) ,$$

With k being the frequency index and L being the number of frequency indices.

In one exemplary embodiment where fs=48000 Hz, it is possible for example to take L=240 samples; in this case, this also gives 240 frequency indices. Other values of L are possible according to the invention.

In one preferred embodiment, the MDCT transform may be truncated when the high band is irrelevant. For example, at 48 kHz, the 20-24 kHz band is not audible. For L=240, the coefficients k=200, . . . ,239 may be ignored, in which case only the N_{K}=200 first coefficients k=0, . . . , N_{K}−1 are kept.

Hereinafter, N_{K}≤L will therefore denote the number of spectral coefficients actually used.

The MDCT transform may be decomposed into a windowing, temporal aliasing and overlap-add operation, followed by a discrete cosine transform (DCT-IV). Omitting the index t to lighten the notations for the intermediate signal (v(n)), the windowing, aliasing and addition operations are given by:

$$\begin{matrix}v ( n ) = w ( \frac{L}{2} - 1 - n ) x ( t , \frac{L}{2} - 1 - n ) + w ( \frac{L}{2} + n ) x ( t , \frac{L}{2} + n ) for 0 \leq n \leq \frac{L}{2} - 1 \\ and v ( n + \frac{L}{2} ) = w ( L - 1 - n ) x ( t , L - 1 + n ) - w ( n ) x ( t , 2 L - 1 - n ) for 0 \leq n \leq \frac{L}{2} - 1\end{matrix}$$

with for example a sinusoidal windowing given by:

$$w ( n ) = sin ( \frac{π}{2 L} ( n + 0.5 ) ) , n = 0 , … , L - 1$$

The DCT-IV discrete cosine transform is given by:

$$X ( t , k ) = {\sum }_{n = 0}^{L - 1} \sqrt{\frac{2}{2 L}} cos ( \frac{π}{2 L} ( n + 0.5 ) ( k + 0.5 ) ) v ( n )$$

In some variants, other windows are possible, as long as they satisfy the conditions of (quasi-) perfect reconstruction. Likewise, other definitions of the MDCT transform may be used, such as the modulated lapped transform (MLT) and the time-domain aliasing cancellation (TDAC) filter bank. Other fast-implementation algorithms and other intermediate transformations than DCT-IV (for example the fast Fourier transform (FFT)) may be used. The benefit of the MDCT transform is that of being critically decimated with L transformed coefficients for each frame of L samples of index t. This transformation gives a transformed signal X(t, k), k=0, . . . , L−1 in the case of a single-channel input signal.

Thus, when multiple successive frames are analyzed and the transformed signal is concatenated, the transformed signal X(t, k), t=T₀, . . . ,T₀+N_{T}−1, k=0, . . . , N_{K}−1, where T₀ is a frame index identifying the first analyzed frame in the group of analyzed frames, may be seen as a two-dimensional matrix of size N_{T}×N_{K} with a time dimension (on the index t) and a frequency dimension (on the index k).

In variants in which the input signal is multichannel, a transform is determined separately for each channel, so as to obtain a transformed signal denoted X(i, t, k), where i=0, . . . , C−1 is the channel index.

In some variants, it is possible to use switching of analysis windows, for example based on detection of transients. In this case, multiple shorter transforms are typically used, giving the same total number of coefficients, but divided into subframes and with a reduced frequency resolution. In the mono case, for a critically decimated filter bank, this gives a transformed signal of the form X(t′, k), k=0, . . . , N_{sub}−1 where t′ is the index of subframes of length L/N_{sub}. The generalization to the multichannel case is not presented here so as not to overload the notations.

In this case, for a temporal medium covering N_{T} frames, the transformed signal is still a two-dimensional matrix, but of size (Nₜ·N_{sub})×(N_{K}/N_{sub}), with a time dimension (on the index t′) and a frequency dimension (on the index k). For simplicity, it is possible to write N_{T′}=N_{T}·N_{sub} and N_{K′}=N_{K}/N_{T}, with a matrix of size N_{T′}×N_{K′}.

In a second embodiment, the transformation involves complex coefficients and may for example be a discrete short-time Fourier transformation.

In this embodiment, the use of the MDCT transform in block 101 of FIG. 1a may be replaced by a short-time Fourier transform (STFT).

The STFT is defined as follows:

$$X ( t , k ) = {\sum }_{n - 0}^{2 L - 1} x ( t , n ) w ( n ) {e}^{- \frac{j π nk}{L}}$$

where w(n) is for example a sinusoidal windowing on 2L samples as defined in the MDCT case. In some variants, other windowing is possible.

Likewise, in some variants, other complex transformations will be used, for example a modulated complex lapped transform (MCLT), which combines an MDCT, for the real part, and a modified discrete sine transform (MDST), for the imaginary part.

Block 101 in this case gives complex coefficients. In this variant embodiment, the complex coefficients of the transform (STFT, MCLT, etc.) are decomposed by block 102 into a real and an imaginary part with:

Xᵣ(t,k)=Re(X(t,k))

and

Xᵢ(t,k)=Im(X(t,k))

Where Re(·) represents the real part and Im(·) represents the imaginary part.

The coding method according to the invention is applied with various possible variants:
Either the real and imaginary parts are seen as 2 channels, with a signal X(i,t,k) that may be seen as a stereo signal, where:

X(0,t,k)=Xᵣ(t,k) and X(1,t,k)=Xᵢ(t,k)
In this case, the transformed signal is a three-dimensional matrix with a channel dimension, a time dimension (on the index t) and a frequency dimension (on the index k).
Or the real and imaginary parts are combined in a sequence whose medium is doubled by interleaving:

$$X ( 2 t , k ) = {X}_{r} ( t , k ) and X ( 2 t + 1 , k ) = {X}_{i} ( t , k )$$

or by concatenation

$$X ( t , k ) = {X}_{r} ( t , k ) and X ( t + {N}_{T} , k ) = {X}_{i} ( t , k )$$

In this case, the transformed signal is still a two-dimensional matrix with a time dimension (on the index t), the duration of which is doubled compared to the real case, and a frequency dimension (on the index k).

The generalization of the complex case to multichannel is not expanded on here because it follows the same principles.

Block 102 decomposes the transformed signal, assumed to be mono and real (without loss of generality), X(t,k) into two parts: amplitudes |X(t,k)|, k=0, . . . , N_{K}−1, and signs, denoted s(t,k),k=0, . . . , N_{K}—1 here and defined for example as follows:

$$s ( t , k ) = \{ \begin{matrix}1 if X ( t , k ) \geq 0 \\ - 1 if X ( t , k ) < 0\end{matrix}$$

This operation is generalized for the case where the transformed signal is multidimensional, and in this case the amplitudes and signs are extracted separately for each coefficient.

In the case of complex coefficients, block 102 therefore provides amplitude components of both the real part and the imaginary part of the signal X(t,k):

$$\vert X ( 2 t , k ) \vert = \vert Xr ( t , k ) \vert ,$$

$$And$$

$$\vert X ( 2 t + 1 , k ) \vert = \vert Xi ( t , k ) \vert$$

and sign components corresponding to the signs of the real and imaginary parts of the signal X(t,k).

The amplitude at the output of block 102 thus corresponds to the amplitudes of the combined real and imaginary parts, and the signs at the output of block 102 correspond to the signs of the combined real and imaginary parts.

Block 103 normalizes and/or compresses the amplitudes |X(t,k)|. The aim is to reduce spectral dynamic range and facilitate processing by an autoencoder. Various exemplary embodiments are described below for the mono case with an MDCT transform.

In one particular embodiment, the compression carried out by this block 103 may be performed by a logarithmic function such as the p-law defined, without loss of generality, over an interval [0, 1] as follows:

$$Y ( t , k ) = \frac{ln ( 1 + μ \frac{\vert X ( t , k ) \vert}{{X}_{norm}} )}{ln ( 1 + μ )} , k = 0 , … , {N}_{k} - 1$$

where the value of μ is for example set to μ=255 and the factor of Xₙₒᵣₘ is a maximum value. The output value Y(t, k) is normalized here to [0, 1].

In one exemplary embodiment, Xₙₒᵣₘ=2¹⁵ is adopted, assuming that the input signals are in the 16-bit PCM format, and that the transform preserves the maximum input level. In some variants, other (constant) fixed values of Xₙₒᵣₘ are possible, in particular with scaling depending on the transform used.

In another exemplary embodiment, Xₙₒᵣₘ is given by:

$${X}_{norm} = {max}_{t = {T}_{0} , … , {T}_{0} + {N}_{T} - 1} ( {max}_{k = T , … , {N}_{K} - 1} \vert X ( t , k ) \vert ) {max}_{t} ( \cdot )$$

here representing the maximum value over all of the frames (or subframes) on a sequence t=T₀, . . . , T₀+N_{T}−1 of the signal to be coded (thereby causing a coding delay if N_{T}>1). This embodiment has the disadvantage of having an additional delay and of requiring transmission of the factor Xₙₒᵣₘ (or its inverse). In one exemplary embodiment, the (positive) value of Xₙₒᵣₘ is coded on 7 bits according to a logarithmic scale—the coding may be in accordance with the ITU-T G.711 standard or simply in accordance with a dictionary of the form 2^{15i/127}, i=0, . . . , 127.

In one variant, Xₙₒᵣₘ may be computed on the basis of all of the elements of the input data as follows:

$${X}_{norm} = {max}_{Ds} ( {max}_{t = {T}_{0} , ... , {T}_{0} + {N}_{T} - 1} ( {max}_{k = 0 , ... , {N}_{K} - 1} \vert X ( t , k ) \vert ) )$$

where Ds represents all of the data at training of the network 120. In this case, this value predetermined during learning does not have to be transmitted, but depends on the learning base and may cause saturations if |X(t, k)|>Xₙₒᵣₘ on a particular test signal. In some cases, the normalization involves coding the maximum level Xₙₒᵣₘ (the link with the multiplexer 107) is not shown so as not to overload FIG. 1a.

In other variant embodiments, compression functions other than the p-law may be used, for example an A-law or a sigmoid function.

In yet another possible variant, no compression or normalization is used. In this case, the module 103 does not exist and it is assumed that the analysis block 104 of the autoencoder 120 uses batch normalization integrated normalization or GSD layers in accordance with the methods of Ballé et al.

In some variants, only amplitude compression is applied so that the maximum amplitude remains preserved, normalizing the signal |X(t, k)| as a function of the maximum value:

$${X}_{norm} = {max}_{t = {T}_{0} , ... , {T}_{0} + {N}_{T} - 1} ( {max}_{k = 0 , ... , {N}_{K} - 1} \vert X ( t , k ) \vert )$$

by applying the compression, and then by multiplying the signal by Xₙₒᵣₘ to keep the maximum value equal to Xₙₒᵣₘ in the one or more current frames of index t=T₀, . . . , T₀+N_{T}−1.

This normalization and/or amplitude compression principle is generalized directly to the multidimensional case, the maximum value being computed over all of the coefficients taking into account all dimensions, either separately (with a maximum value per channel) or simultaneously (with a global maximum value).

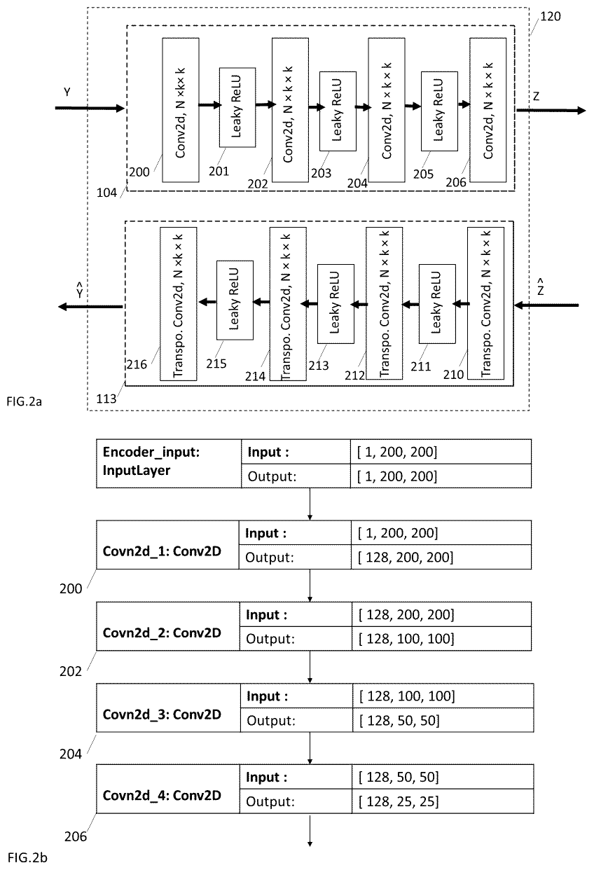

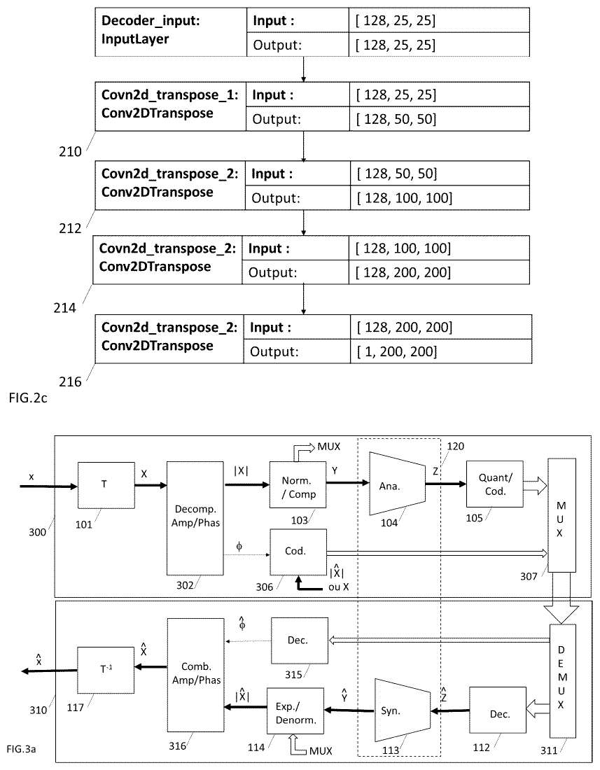

Block 104 represents the analysis part of one example of an autoencoder. One exemplary embodiment of the block 104 is given with reference to FIG. 2a described below. Here, the input of the network corresponds to the amplitudes of the transformed and compressed signal |Y(t, k)|; this signal—here in the mono case—corresponds to a spectrogram and may be seen as a two-dimensional image (of size N_{T}×N_{K} in the preferred embodiment) when multiple successive frames or sub-frames are grouped together as described above.

In one exemplary embodiment, consideration is given to the case of a group of N_{T}=200 frames of 240 samples (that is to say one second of a signal at 48 kHz), thereby giving 200×200 coefficients if N_{K}=200 MDCT coefficients are kept on the 0-20 KHz band. In some variants, the signal may be analyzed over a shorter or longer duration, the extreme case being given by a single frame N_{T}=1 of 20 ms to obtain N_{K}=800 MDCT coefficients on the 0-20 KHz band at 48 kHz (only the first 800 out of 960 coefficients per frame are kept).

In some variants, a filter bank will be adopted. For example, taking the case of a different sampling frequency, it is possible to take 20 subframes in a 20 ms frame at 32 kHz, thereby giving 20×40 MDCT coefficients on the 0-16 kHz band at 32 kHz for block 104. The output of the encoder part 104 is the representation of the signal in a latent space denoted Z(m, p, q), where m is a feature map index, and p,q are the row (time) and column (frequency) indices in each feature map.

Block 104 is responsible for finding a representation of the signal in a latent space denoted Z(m, p, q), such that:

$$Z ( m , p , q ) = {f}_{a} ( \vert Y ( t , k ) \vert ; {θ}_{a} ) ,$$

where f_{α} is the function applied by the analysis part of the network and θ_{α} corresponds to the parameters of the neural network. These parameters will be learned during training of the model.

In one particular embodiment in which the autoencoder follows the principle of a variational autoencoder in the learning phase, each latent map is assumed to follow a Gaussian distribution such that: P_{Z(m,p,q)}˜N(0, σₘ²) according to Ballé et al. (2017).

The distribution of the values is assumed to be homogeneous, and the variance σₘ², is estimated for each feature map. In some variants, a hyperlatent version according to Ballé et al. (2018) is used, where P_{Z(m,p,q)}˜N(0, σ_{m,p,q}²), which is tantamount to applying a Gaussian model to each “pixel” of index p, q in each map of index m.

The latent representation Z(m, p, q), also called latent space, corresponds to the bottleneck of the autoencoder.

In the examples given above, there will be for example a latent space of size 128×25×25 for the case of real input data of size 200×200 for the exemplary network given in FIG. 2a.

If assuming scalar quantization coding (block 105) and entropy coding, during the training of the autoencoder, the parameters θ_{α} (coding) and θ_{d} (decoding) are optimized according to the following cost function:

$$ℒ ( λ ) = R ( \hat{Z} ( m , p , q ) ) + λ D ( Y ( t , k ) , \hat{Y} ( t , k ) )$$

where D is a measure of distortion defined for example by:

$$D ( Y ( t , k ) , \hat{Y} ( t , k ) ) = {E}_{Y ( t , k )} ∼ {p}_{Y ( t , k )} {‖ Y ( t , k ) - \hat{Y} ( t , k ) ‖}^{2}$$

where p_{γ(t,k)} is the probability distribution of Y(t,k).

R is the estimate of the bit rate required to transmit the latent space, defined as follows:

$$R ( \hat{Z} ( m , p , q ) ) = {E}_{Y ( t , k )} ∼ {p}_{Y ( t , k )} [ - {log}_{2} {p}_{Z ( m )} ( \hat{Z} ( m , p , q ) ) ]$$

with p_{Z(m)} the probability distribution of Z(m,p,q) (network learning phase). In practice, for the learning phase, the bit rate R is evaluated by summing over m, p, q the entropy estimated according to the Gaussian probability model and the distortion is evaluated by summing the squared error over the various input/output data.

For the phase of use of the network, the bit rate R is replaced by the real bit rate of an entropy coding (for example arithmetic coding).

The compromise between reconstruction faithfulness and bit rate may be parameterized by the value λ. A small value of λ will favor reconstruction quality to the detriment of bit rate, and a large value of λ will favor bit rate, but the quality of the audio signal at output will be degraded.

In the case of vector quantization, the neural network is trained to minimize distortion at a given bit rate.

This latent space, which is representative of the amplitude components of the audio signal, is coded in block 105, for example by scalar quantization and entropy coding (for example arithmetic coding), as in the abovementioned articles by Balle et al. It should be noted that, during learning, entropy coding is typically replaced by a theoretical quantization model and an estimate of Shannon entropy, as in the articles by Ballé et al. In some variants, the latent space is coded (block 105) by vector quantization at a given bit rate. One exemplary embodiment consists in applying a gain-shape vector quantization on the basis of a global bit budget allocated to the quantization of the latent space, with a global gain (scalar) and a shape coded based on a block of 8 coefficients by algebraic vector quantization according to the article by S. Ragot et al., “Low-Complexity Multi-Rate Lattice Vector Quantization with Application to Wideband TCX Speech Coding at 32 kbit/s” Proc. ICASSP, Montreal, Canada, May 2004. This method is implemented for example in the 3GPP AMR-WB+ and EVS codecs.

According to the invention, the signs, denoted s(t,k) for the case of a real transform of a mono signal, are coded separately by block 106 according to embodiments described below.

The latent representation coded in 105, along with the signs coded in 106, are multiplexed in the bitstream in block 107.

Various embodiments of the coding of the signs (block 106) according to the invention will now be described. According to the invention, three main variants are developed for the one or more current frames:
A. Coding all signs
B. Coding all signs in the low frequencies and selectively coding signs in the high frequencies (with random uncoded signs and/or uncoded signs estimated by reconstruction/phase prediction)—phases may be estimated by performing a modified discrete sine transform (MDST) on the signal reconstructed in the preceding frames, and the uncoded signs are then deduced from the predicted phases as detailed below.
C. Coding all signs in the low frequencies and reconstruction/phase prediction to estimate signs in the high frequencies

For amplitudes coded at a given bit rate, these three sign coding variants make it possible to achieve different bit rate/quality compromises: variant A gives the best quality but at a high bit rate, variant B gives an intermediate quality at a lower bit rate, and finally variant C gives a more limited quality but at a reduced bit rate. The limit frequency delimiting the low and high frequencies is a parameter that makes it possible to control this compromise more finely, and this frequency, denoted N_{bf} below, may be fixed or adaptive.

In some variants, it will be possible to combine variants B and C by defining multiple frequency sub-bands: a low band (in which all bits are coded), an intermediate band (in which a selection of bits are coded), and a high band (in which no bits are transmitted, and sign bits are estimated at the decoder).

It should be noted that the signs s(t, k), t=T₀, . . . , T₀+N_{T}−1, k=0, . . . , N_{K}−1 correspond equivalently to a binary matrix

$$b ( t , k ) = \{ \begin{matrix}0 & if s ( t , k ) = 1 \\ 1 & if s ( t , k ) = - 1\end{matrix}$$

of size N_{T}×N_{K}, this corresponding for example to 40,000 bits over one second (therefore a bit rate of 40 kbit/s) for the example N_{T}=200, N_{K}=200 of a signal sampled at 48 KHz and coded in blocks of 200 frames covering 1 second. In some variants, the complementary convention (which inverts the definition of the bits 0 and 1) may be used.

FIG. 1b illustrates a direct embodiment (variant A), in which these sign bits b(t, k) are simply multiplexed in a predetermined order in the bitstream, for example by writing the signs b(t, k) frame by frame, t ranging from T₀ to T₀+N_{K}−1 and in a given frame in a predetermined order, for example from k=0 to k=N_{K}−1. In some variants, the signs b(t, k) may be written in any given order that corresponds to a two-dimensional permutation of the matrix of size N_{T}×N_{K}.

It should be noted that this coding is easily generalized to the multichannel case, since it is sufficient to define the sign bits b(i, t, k) corresponding to X(i, t, k) and to multiplex all of the bits on all 3 dimensions (i, t, k).

FIG. 1c illustrates another embodiment (variant B) in which not all of the signs s(t, k) are coded in order to reduce the bit rate required for coding the signs. In this exemplary embodiment, all of the signs of the low frequencies k=0, . . . , N_{bf}−1 and a subset of Nₚₖ signs of the high frequencies k=N_{bf} . . . , N_{K}−1 are coded, where Nos may be set to a fixed value (for example N_{bf}=80 for N_{K}=200 in the previous example) or an adaptive value (depending on the signal), and Nₚₖ is also set to a predetermined value (Nₚₖ=2 in FIG. 1c). According to the embodiments, variant B may code, in addition to the low-frequency signs and the selected high-frequency bits, metadata on a budget of B_{bf} bits. In some variants, it is possible to use a division with more than 2 frequency sub-bands (in addition to the low and high bands) so as to allocate the number of sign bits coded per sub-band more finely. Preferably, the signs in the first frequency band will all be coded, since it is important to preserve the sign information for the low frequencies.

It should be noted that this coding is easily generalized to the multichannel case, since it is sufficient to define the sign bits b(i, t, k) corresponding to X(i,t, k) and to repeat the coding and multiplexing of the signs for each channel of index i.

Various methods for selecting and/or coding (indexing) the subset of signs are possible, considering firstly the simple case of 2 sub-bands and a single high-frequency sub-band:
Variant B1:
   In one variant (variant B1a), a search for the Nₚₖ largest peaks among N_{hf} high-frequency coefficients (N_{hf}=N_{K}−N_{bf}) is carried out on the original amplitude spectrum. The search Nₚₖ for the largest peaks may be carried out simply in 2 steps, firstly by searching for the index lines k=N_{bf}+1, . . . , N_{K}−2 that verify peaks on the lines that verify |X(t, k)|>|X(t, k−1)| and |X(t, k)|>|X(t, k+1)|, and then ordering the obtained indices k so as to retain the positions l₀(t), . . . , l_{N}_{ₚₖ}−1(t) corresponding to the Nₚₖ largest values |X(t, k)|. In some variants, other methods for detecting Nₚₖ amplitude peaks may be used, for example the method described in clause 5.4.2.4.2 of the 3GPP TS 26.447 standard.
   The positions l₀(t), . . . , l_{N}_{ₚₖ}−1(t) of the Nₚₖ signs from among N_{hf} high-frequency coefficients are coded using combinatorial coding techniques. For example, when Nₚₖ=2 and N_{hf}=200−80=120, there will be 7140 possible combinations, that is to say B_{hf}=13 bits per frame (that is to say 2.6 kbit/s for 200 frames per second). The sign coding bit rate is then: (80+2+13)×200=19 kbit/s. In some variants, it is possible to divide the high band into separate sub-bands and apply the method in each sub-band, or into series of interleaved positions (“tracks”) and apply the method for each track (tracks are defined here in the sense of a decomposition of positions in polyphase form similar to pulse coding in the ACELP method from the ITU-T G.729 standard).
   In another variant (variant B1b), a block error correction code is used to jointly code the position and the values of the Nₚₖ signs. In this case, the signed spectrum X(t, k) is used and the binary correction code [Nc, Kc, Dc], where Nc is the length (in bits), Kc is the number of check bits, and Dc is the Hamming distance, is converted into values +1 and −1 instead of 1 and 0 (respectively). The position of the signs and the associated sign values are coded together. For a frame of given index t, the coding in block 106 is then carried out for sub-blocks of (successive or interleaved) frequency lines of length Kc, through a scalar product of X(t, k) and the various codewords (with values +1/−1), and while retaining the codeword that maximizes the scalar product. The principle of this correction code-based coding is detailed for example in the document S. Ragot, L′hexacode, le code de Golay code et le réseau de Leech: définition, construction, application en quantification [Hexacode, Golay code and the Leech network: definition, construction, application in quantization], master's thesis, Department of Electrical Engineering and Computer Engineering, University of Sherbrooke, QC, Canada, December 1999
   In one exemplary embodiment, it is possible to take an extended Hamming code of the type [2^{m}, 2^{m}−m−1, 4] the values of which are +/−1 and not 0/1, this meaning that the signs (and their positions) of 2^{m} lines are represented on 2^{m}−m−1 bits. For example, by taking an extended Hamming code [8, 4, 4], the N_{hf}=200-80-120 high-frequency sign bits are divided into 15 blocks of 8 bits, and decoding (taking the signed spectrum as soft bit value) is used to obtain a total of 15 blocks of 4 check bits, that is to say 60 bits per frame (or 12 kbit/s for 200 frames per second) to code the signs (and their positions).
   The coding bit rate of the sign bits is therefore (80+60)×200=28 kbit/s. In some variants, other block correction codes will be used. In some variants, the correction codes may be interleaved so as to make it easier to distribute the coded sign bits.
   In other sub-variants (variant B1c), it is also possible to classify the sub-bands as a tonal band or a noise band in accordance with for example a criterion of spectral flatness known from the prior art, and then signs will be coded only in the tonal bands. This spectral flatness criterion is estimated on the original amplitudes, and a tone indication must be transmitted for each sub-band in addition to the positions.
Variant B2: the search for the Nₚₖ largest peaks is carried out on the coded amplitude spectrum, meaning that the position of the peaks does not have to be transmitted, because the same information (coded amplitude spectrum) may be available at the decoder. However, this assumes that block 106 has access to the output (coded latent space) of block 105 and that the synthesis part of the autoencoder (block 113) is applied to carry out local decoding.
In other sub-variants, it is also possible to classify the sub-bands as a tonal band or a noise band in accordance with for example a criterion of spectral flatness known from the prior art, and then signs will be coded only in the tonal bands. This spectral flatness criterion is estimated on the amplitudes that are decoded locally (and therefore not transmitted).

In some variants, the selection of the position of the signs may be based on an estimation of the frequency masking curve to detect the most perceptually significant peaks, for example on the basis of a signal-to-mask ratio using the methods known from the prior art.

FIG. 1d illustrates another embodiment (variant C) in which all of the signs in the low frequencies are coded (multiplexed) in block 120 and the bits of the high frequencies are not transmitted to the encoder. These missing data are estimated at the decoder by reconstruction/phase prediction in order to estimate signs in the high frequencies.

Thus, in this variant, all signs of the low frequencies k=0, . . . , N_{bf}−1 and no signs of the high frequencies k=N_{bf}, . . . N_{K}−1 are coded, where N_{bf} may be set to a fixed or adaptive value.

For the previous example, where N_{T}=200, N_{K}=200 of a signal sampled at 48 KHz and coded in blocks of 200 frames covering 1 second, the bit rate required for the signs is for example 16,000 bits over one second (that is to say 16 kbit/s) when N_{bf}=80 (that is to say a cutoff frequency of 8 kHz).

The above methods are generalized to the case of multiple sub-bands, and also to the case of a filter bank, of a complex transform separated into real or imaginary parts, or to the multichannel case.

In other variants, the various embodiments of the coding of the signs may be adapted if the coefficients are divided into frequency sub-bands and the sign coding is carried out separately for each sub-band.

FIG. 1a also shows the decoder 110 that is now described.

Block 111 demultiplexes the bitstream to find firstly the coded representations of the latent space Z(m) and secondly the signs s(k).

The latent space is decoded in 112. The synthesis part (block 113) of the autoencoder 120 reconstructs the spectrum Ŷ(t, k) from the decoded latent space in the form:

Ŷ(t,k)=gₛ(\hat{Z}(m,p,q);θ_{d})

Block 114 makes it possible to decompress the amplitude and to denormalize the amplitude (if block 103 has been implemented). In this case, use is made for example of an inverse logarithmic function such as the inverse p-law defined by:

$$\vert \hat{X} ( t , k ) \vert = \frac{1}{μ} [ ( 1 + μ ) \vert \hat{Y} ( t , k ) \vert - 1 ]$$

When a variant of block 103 is implemented, block 114 is adapted accordingly. In some cases, the normalization involves decoding a maximum level (the link with the demultiplexer 111) is not shown so as not to overload FIG. 1a.

The signs of the signal are decoded in block 115 as follows:

If all of the sign bits b(t, k),t=T₀, . . . , T₀+N_{T}−1, k=0, . . . , N_{K}−1 have been multiplexed one by one in the bitstream, the received bits b(t, k) are demultiplexed in the order they were written in block 106. When the bitstream has not experienced any binary error, this will give \hat{b}(t, k)=b(t, k).

Like with the coding, a distinction is drawn between 3 variants of decoding the sign information (variants A, B, C).

In variant A, the decoding of the signs is reduced to demultiplexing the sign bits according to the order used in coding and converting the value of the sign bit with for example:

$$\hat{s} ( t , k ) = \{ \begin{matrix}1 & if \hat{b} ( t , k ) = 0 \\ - 1 & if \hat{b} ( t , k ) = 1\end{matrix}$$

In variant B, the signs are decoded as in variant A for the sign bits of the low frequencies. A portion of the high-frequency signs is coded, the Nₚₖ bits per frame are demultiplexed and the positions l₀(t), . . . , l_{N}_{ₚₖ}−1(t) are decoded to find the corresponding positions. The positions are decoded according to the coding method that was used, either using combinatorial decoding methods or using error correction codes.

In some variants (B1a), the positions l₀, . . . , l_{N}_{ₚₖ}−1 are determined based on the decoded amplitudes |\hat{X}(t, k)|, possibly with the estimation of a masking curve.

This therefore gives:

$$\hat{s} ( t , k ) = \{ \begin{matrix}1 & if \hat{b} ( t , k ) = 0 \\ - 1 & if \hat{b} ( t , k ) = 1\end{matrix}$$

for k=l₀, . . . , l_{N}_{ₚₖ}−1.

For the rest of the signs of the high frequencies, in one variant, all of the signs are given a random value, and in another variant, the same value is given to all of the signs, that is to say

$$\hat{s} ( t , k ) = {( - 1 )}^{random ( )}$$

for k∈{N_{bf}, . . . , N_{K}−1}\{l₀, . . . , l_{N}_{_{sig}}−1}, where random( ) is a binary random draw according to the prior art.

In other variants (B1b), the signs and their positions are decoded together to directly obtain ŝ(t, k), k=N_{bf}, . . . , N_{K}−1. For example, taking an extended Hamming code [8, 4, 4], the N_{hf}=200−80=120 high-frequency sign bits are divided into 15 blocks of 8 bits. Demultiplexing is carried out 8 times on an index on 4 bits and “correction coding” is used to obtain the codeword (among 16 possibilities) with values +/−1, directly giving the sequence ŝ(t, k) over 8 (consecutive or interleaved) frequency lines.

In variant C, illustrated in FIG. 1d, the signs are decoded as in variant A for the sign bits of the low frequencies (block 130). The signs of the high frequencies are missing information, and they are estimated for example using methods described in the 3GPP TS 26.447 standard, clause 5.4.2.4.3 (tonal prediction). It should be noted here that, unlike a correction of frame losses, the amplitude information is available here for the high frequencies. Only the sign information is missing, and it is therefore estimated. One exemplary embodiment consists in adapting the MDCT frame loss correction methods described in clause 5.4.2.4.3 of the 3GPP TS 26.447 standard. The phases may be estimated by carrying out a modified discrete sine transform (MDST) on the signal reconstructed in the preceding frames, the uncoded signs then being deduced from the predicted phases. In particular, the signs may be determined at the decoder by retaining the sign of the result from equation 146 of the 3GPP TS 26.447 standard.

Block 116 makes it possible to combine the decoded signs and the amplitudes so as to reconstruct the initial frames according to the following formula:

\hat{X}(t,k)=|\hat{X}(t,k)|·ŝ(t,k)

Block 117 applies the inverse MDCT so as to obtain the decoded signal \hat{x}(n). When the number N_{K} of MDCT coefficients used is such that N_{K}<L, block 117 will add L−N_{K} coefficients to zero at the end of the spectrum of each frame, in order to recover a spectrum of L coefficients.

Each operation of the inverse MDCT works on L coefficients so as to produce L audio samples in the time domain. The inverse MDCT may be decomposed into a DCT-IV followed by windowing, aliasing and addition operations. The DCT-IV is given by:

$$u ( n ) = {\sum }_{k = 0}^{2 L - 1} \sqrt{\frac{2}{L}} cos ( \frac{π}{L} ( k + 0.5 ) ( n + 0.5 ) ) \hat{X} ( t , k ) for 0 \leq n \leq L - 1$$

The windowing, aliasing and addition operations use half the samples from the DCT-IV output of the current frame with half of those from the DCT-IV output of the preceding frame according to:

$$\hat{x} ( t , n ) = w ( n ) u ( \frac{L}{2} - 1 - n ) + w ( L - 1 - n ) {u}_{old} ( n ) for 0 \leq n \leq \frac{L}{2} - 1$$

$$\hat{x} ( t , n + \frac{L}{2} ) = w ( \frac{L}{2} + n ) u ( n ) - w ( \frac{L}{2} - 1 - n ) {u}_{old} ( \frac{L}{2} - 1 - n ) for 0 \leq n \leq \frac{L}{2} - 1$$

$$where$$

$$w ( n ) = sin ( \frac{π}{2 L} ( n + 0.5 ) ) for 0 \leq n \leq L - 1$$

The unused half of u( ) is stored as u_{old}( ) for use in the following frame:

$${u}_{old} ( n ) = u ( n + \frac{L}{2} ) for 0 \leq n \leq \frac{L}{2} - 1$$

FIG. 2a illustrates the elements of the autoencoder 120, in particular the elements of the analysis part 104 and the synthesis part 113.

The analysis part of block 104 consists in this example of four convolutional layers (blocks 200, 202, 204 and 206). Each layer consists of a 2D convolution with filters of dimension K×K (for example 5×5), followed by a decimation by 2 of the size of the feature maps. The size of the feature maps becomes increasingly small as the analysis part progresses. However, the dimensions at the input and at the output of the layers are generally different.

FIG. 2b shows one exemplary application of the layers of blocks 200, 202, 204 and 206 of the analysis part. The first layer represented by block 200 receives a mono signal (1, 200, 200). At the output of this layer, a feature map of size (128, 200, 200) is received, where N=128 is the number of feature maps under consideration in this layer. The following block 202 receives a multichannel signal of size (128, 200, 200), and with decimation by 2 of the size of the feature map, a feature map of size (128, 100, 100) is obtained at output. The same process is applied by the layer 204, where we have an activation layer of size (128, 50, 50) at output. Finally, the last block 206 gives a signal of size (128, 25, 25).

Following each of the first 3 2D convolution layers, a “Leaky ReLU” activation function is used in block 201, 203 and 205. The “Leaky ReLU” function is defined as follows:

$$LeakyRelu ( x ) = \{ \begin{matrix}x , & if x \geq 0 \\ α x , & otherwise\end{matrix}$$

with α a negative-slope constant having for example the value α=0.01.

For the last layer, there is no activation function so as not to limit the values that y is able to take at the output of the layer.

In some variants, the ReLU function may be replaced by other functions known from the prior art, for example an ELU (Exponential Linear Unit) function.

For the synthesis part (block 113), the latter has an architecture constructed as a mirror image with respect to the analysis part. There are 4 successive 2D transposed convolution layers (blocks 216, 214, 212 and 210). The addition of the transposed convolution allows a richer non-linear interpolation than a simple linear weighting of the values. In the synthesis part, it is the last layer, block 216, that has N inputs and the number of channels of the signal Y(k) at output, and the other layers have N inputs and outputs. Like for the analysis part, after each of the first 3 layers, a “Leaky ReLU” activation function is used in blocks 215, 213 and 211.

FIG. 2c shows one exemplary application of the layers of blocks 210, 212, 214 and 216 of the synthesis part. The block 210 receives a multichannel signal of size (128, 25, 25) and gives a feature map of size (128, 50, 50). In the same way, blocks 212 and 214 give layers of size (128, 100, 100) and (128, 200, 200), respectively. Finally, layer 216 receives a signal of size (128, 200, 200) and gives a signal of the same size as the original mono signal (1, 200, 200).

The number of feature maps N makes it possible to give the model more or fewer degrees of freedom to represent the input signals. For training carried out only with a distortion constraint without a bit rate constraint (λ=0), the higher the value of N, the greater the reconstruction quality of the model will be. For a given value of N, training carried out only with a distortion constraint (λ=0) makes it possible to have an estimate of the maximum reconstruction quality that the model may expect with N feature maps. With the introduction of the bit rate constraint (λ>0), the reconstruction quality will necessarily be poorer than this maximum quality.

FIG. 3a now illustrates a second embodiment of an encoder 300 and of a decoder 310 according to the invention, along with the steps of a coding method and of a decoding method according to a second embodiment of the invention. While the first embodiment decomposes the audio signal into amplitudes and signs, the second embodiment decomposes the audio signal into amplitudes and phases. The principles of coding the signs as described for the first embodiment are extended to the case of the phases, the main difference being that, instead of having 1 bit to represent a sign (or a sign bit), there will generally be multiple bits per phase (for example 7 low-frequency bits and 5 high-frequency bits). When the phase is coded on 1 bit, this will result in a case similar to the first embodiment where the sign is coded.

In this figure, the transform block 101 remains the same as that described with reference to FIG. 1a, but with a complex transform (STFT or MCLT for example).

Block 302 differs from block 102 of FIG. 1a. This block 302 decomposes the transformed signal X(t,k) into two parts: amplitudes |X(t,k)|, t=T₀, . . . , T₀+N_{T}−1, k=0, . . . , N_{K}−1 and phases, here denoted ϕ(t, k)=arg X(t,k), t=T₀, . . . , T₀+N_{T}−1 k=0, . . . , N_{K}−1 where arg (·) is the complex argument.

For the amplitude coding, blocks 103 to 105 described with reference to FIG. 1a remain unchanged.

In this embodiment, block 306 codes the phases thus obtained from the input signal separately. These coded phases are then multiplexed in the bitstream in 307, with the latent representation coded in 105. The main difference compared to the embodiment of FIG. 1a is that the phase information is not coded on 1 bit but on a larger budget, for example 7 bits per phase, for a uniform scalar quantization dictionary on [0, 2π], with a step of π/64. In some variants, the budget for coding a phase may depend on the frequency band, with for example 7 bits per phase at low frequencies and 5 bits per phase at high frequencies.

Like in the first embodiment, 3 variants may be defined:
A. Coding all phases ϕ(t, k), t=T₀, . . . , T₀+N_{T}−1, k=0, . . . , N_{K}−1
B. Coding all phases in the low frequencies and selectively coding phases in the high frequencies (with random uncoded phases and/or uncoded phases estimated by reconstruction/phase prediction). In this case, like for the coding of signs in the first embodiment, it is possible to select positions of the Nₚₖ largest “peaks” and to code/multiplex the phases at these positions; the Nₚₖ positions of the peaks are coded as in the first embodiment (variants B1a or B1c).
C. Coding all phases in the low frequencies and reconstruction/phase prediction to estimate phases in the high frequencies. In this case, the phases are coded only for the low frequencies, for k=0, . . . , N_{bf}−1.

At decoding, block 311 demultiplexes the bitstream to find firstly the coded representations of the latent space Z(m,p,q) representing the amplitude portion |X(t,k)|, and secondly the coded version of the phases ϕ(t, k).

Blocks 112 to 114 remain unchanged compared to those described with reference to FIG. 1a.

Block 315 decodes the phases on the basis of the variants A, B used at coding, in order to combine them with the decoded amplitudes in 316. Variant C is considered in FIG. 3b. The inverse transform block 117 remains unchanged compared to block 117 of FIG. 1a.

FIG. 3b now illustrates another embodiment of an encoder 400 and of a decoder 410 according to the invention, along with the steps of a coding method and of a decoding method according to one embodiment of the invention.

In this embodiment, block 401 uses a short-time Fourier transform STFT. Block 402 decomposes the transformed signal X(t,k) into two parts: amplitudes |X(t,k)|, k=0, . . . , N_{K}−1 and phases, here denoted Φ(t,k),k=0, . . . , N_{K}−1.

In this embodiment, only a portion of the phases, for example only the portion corresponding to the low frequencies of the transformed signal (Φ₁), is coded by block 406.

In one variant, a portion of the phase components of the high frequencies may also be coded.

In one exemplary embodiment, with an STFT where L=240 samples, low frequency is understood to mean the frequency lines of index 0 to N_{bf}−1=79, this corresponding to approximately a frequency band of 8 KHz.

For the amplitude coding, blocks 103 to 105 described with reference to FIG. 1a remain unchanged.

The latent representation coded in 105 is then multiplexed in the bitstream in 407 with the portion, coded in 406, of the phases of the transformed signal.

At decoding, block 411 demultiplexes the bitstream to find the coded representations of the latent space Z (m,p,q) and a portion of the phases of the signal.

This phase portion for the low frequencies is decoded in 415 (\hat{Φ}₁).

Blocks 112 to 114 remain unchanged compared to those described with reference to FIG. 1a.

The other portion of the phases (\hat{Φ}₂) for the high frequencies is reconstructed by block 418. For this purpose, after the inverse compression of block 114, an algorithm for reconstructing the uncoded phases of the STFT is used in this block 418. This algorithm makes it possible to invert the amplitude spectrogram using an algorithm as described in the document D. W. Griffin and J. S. Lim, “Signal estimation from modified short-time Fourier transform,” IEEE Trans. ASSP, vol. 32, no. 2, pp. 236-243, April 1984. Given an amplitude matrix for a short-time Fourier transform |Ŷ(t, k)|, the algorithm randomly initializes the phases (\hat{Φ}₂ corresponding to ϕ(t, k), k=N_{bf}, . . . , N_{K}−1, then alternates between the forward and inverse STFT operations. Preferably, this estimation of the high-frequency phases may be implemented by processing at a sampling frequency lower than the sampling frequency fs of the input/output signal.

Block 416 combines the decoded amplitudes and the decoded (\hat{Φ}₁) and reconstructed (\hat{Φ}₂) phases, and then the inverse STFT is applied in block 417 in order to reconstruct the original signal.

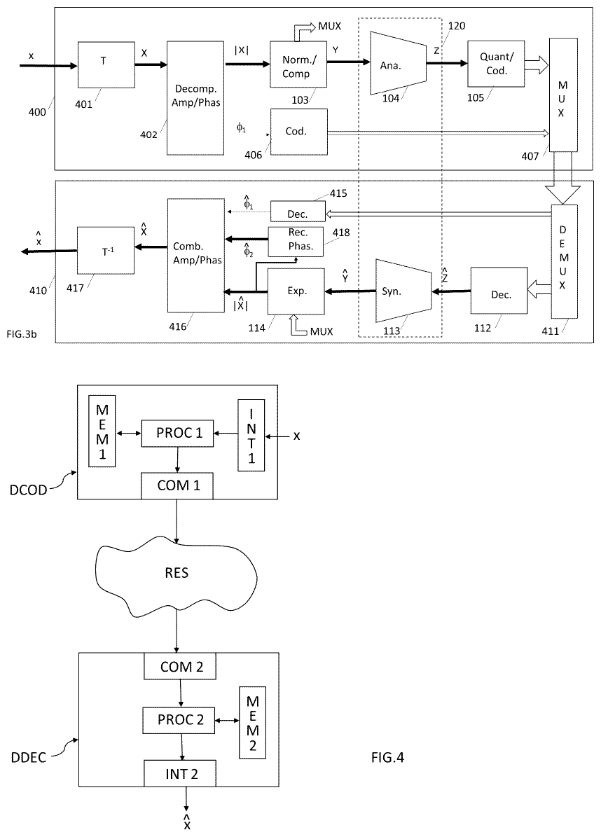

FIG. 4 illustrates a coding device DCOD and a decoding device DDEC, within the sense of the invention, these devices being dual to each other (in the sense of “reversible”) and connected to one another by a communication network RES.

The coding device DCOD comprises a processing circuit typically including:
a memory MEM1 for storing instruction data of a computer program within the sense of the invention (these instructions possibly being distributed between the encoder DCOD and the decoder DDEC);
an interface INT1 for receiving an original mono or multichannel audio signal x;
a processor PROC1 for receiving this signal and processing it by executing the computer program instructions stored in the memory MEM1, with a view to coding it; in particular, the processor being able to control an analysis module of a neural network-based autoencoder; and
a communication interface COM 1 for transmitting the coded signals via the network.

The decoding device DDEC comprises its own processing circuit, typically including:
a memory MEM2 for storing instruction data of a computer program within the sense of the invention (these instructions possibly being distributed between the encoder DCOD and the decoder DDEC as indicated above);
an interface COM2 for receiving the coded signals from the network RES with a view to compression-decoding them within the sense of the invention;
a processor PROC2 for processing these signals by executing the computer program instructions stored in the memory MEM2, with a view to decoding them; in particular, the processor being able to control a synthesis module of a neural network-based autoencoder; and
an output interface INT2 for delivering the decoded audio signal \hat{x}.

Of course, this FIG. 4 illustrates one example of a structural embodiment of a codec (encoder or decoder) within the sense of the invention. FIGS. 1 to 3, commented on above, describe functional embodiments of these codecs in detail.

1. A coding method for coding an audio signal, the method being implemented by a coding device and comprising:
decomposing the audio signal into at least amplitude components and sign or phase components;
analyzing the amplitude components by way of a neural network-based autoencoder so as to obtain a latent space representative of the amplitude components of the audio signal;
coding the obtained latent space; and
coding at least a portion of the sign or phase components.

2. The coding method as claimed in claim 1, furthermore comprising compressing the amplitude components before they are analyzed by the autoencoder.

3. The coding method as claimed in claim 2, wherein the amplitude components are compressed by a logarithmic function.

4. The coding method as claimed in claim 1, comprising, before the decomposing, obtaining the audio signal by a modified discrete transform (MDCT transform) applied to an input audio signal.

5. The coding method as claimed in claim 1, wherein the audio signal is a multichannel signal.

6. The coding method as claimed in claim 1, wherein the audio signal is a complex signal comprising a real and an imaginary part resulting from a transformation of an input audio signal, the amplitude components resulting from the decomposing corresponding to the amplitudes of the combined real and imaginary parts and the sign or phase components corresponding to the signs or phases of the combined real and imaginary parts.

7. The coding method as claimed in claim 1, wherein all of the sign or phase components of the audio signal are coded.

8. The coding method as claimed in claim 1, wherein only the sign or phase components corresponding to low frequencies of the audio signal are coded.

9. The coding method as claimed in claim 1, wherein the sign or phase components corresponding to low frequencies of the audio signal are coded and selective coding is carried out for the sign or phase components corresponding to high frequencies of the audio signal.

10. The coding method as claimed in claim 9, wherein positions of the sign or phase components selected for the selective coding are also coded.

11. The coding method as claimed in claim 9, wherein positions of the selected sign or phase components and the associated values are coded together.

12. A decoding method for decoding an audio signal, the method being implemented by a decoding device and comprising:
decoding sign or phase components of the audio signal;
decoding a latent space representative of amplitude components of the audio signal;
synthesizing the amplitude components of the audio signal by way of a neural network-based autoencoder, from the decoded latent space; and
combining the decoded amplitude components and the decoded sign or phase components so as to obtain a decoded audio signal.

13. The decoding method as claimed in claim 8, wherein, in response to the decoded phase components corresponding to one portion of the phase components of the audio signal, another portion of the phase components is reconstructed before the combining.

14. A coding device comprising:
a processing circuit configured to:
decompose an audio signal into at least amplitude components and sign or phase components;
analyze the amplitude components by way of a neural network-based autoencoder so as to obtain a latent space representative of the amplitude components of the audio signal;
code the obtained latent space; and
code at least a portion of the sign or phase components.

15. A decoding device comprising:
a processing circuit configured to:
decode sign or phase components of the audio signal;
decode a latent space representative of amplitude components of the audio signal;
synthesize the amplitude components of the audio signal by way of a neural network-based autoencoder, from the decoded latent space; and
combine the decoded amplitude components and the decoded sign or phase components so as to obtain a decoded audio signal.

16. A non-transitory storage medium able to be read by a processor and storing a computer program comprising instructions for executing the coding method as claimed in claim 1.

17. A non-transitory storage medium able to be read by a processor and storing a computer program comprising instructions for executing the decoding method as claimed in claim 12.
